(19) United States
(12) Patent Application Publication
(10) Pub. No.: US 2021/0266102 A1
(43) Pub. Date: Aug. 26, 2021

(54) Systems and Methods for Relaying and Updating Payload Counter Data Between Hearing Devices

(71) Applicant: SONOVA AG, Staefa (CH)

(72) Inventors: Federico Ferrari, Bern (CH); Alessandro Gallo, Murten (CH); Amre El-Hoiydi, Neuchâtel (CH)

(73) Assignee: SONOVA AG

(21) Appl. No.: 17/118,236

(22) Filed: Dec. 10, 2020

Related U.S. Application Data
(63) Continuation-in-part of application No. PCT/IB2020/051560, filed on Feb. 24, 2020.

(51) Int. Cl. H04L 1/00; H04W 4/80; H04W 12/106; H04W 12/033

(52) U.S. Cl. CPC H04L 1/0076; H04W 4/80; H04L 2001/0097; H04W 12/033; H04W 12/106

(57) ABSTRACT

An exemplary method comprises a first hearing device receiving a data packet transmitted from a source device; incrementing, in response to receiving the data packet, a first payload counter value; receiving a second payload counter value transmitted from a second hearing device; comparing the second payload counter value to the first payload counter value; and performing, based on the comparing, an action with respect to the first payload counter value.

### RELATED APPLICATIONS

This application is a continuation-in-part of PCT Patent Application No. PCT/IB2020/051560, filed Feb. 24, 2020, which application is incorporated herein by reference in its entirety.

### BACKGROUND INFORMATION

In some situations, it is desirable for a hearing system that includes first and second hearing devices to render (e.g., acoustically present) streaming audio from a source device (e.g., a Bluetooth-enabled smartphone) to a user using a wireless link (e.g., a Bluetooth link) that provides a heightened degree of protection against third party attacks. To this end, the first hearing device may establish the wireless link with the source device and receive audio packets transmitted from the source device over the wireless link in accordance with a secure, encrypted transmission protocol (e.g., Bluetooth Secure Connections). The secure, encrypted transmission protocol may require the source device to maintain a transmission payload counter instance and each of the first and second hearing devices to maintain a receiving payload counter instance to keep track of each packet that is transmitted from the source and received by the first and second hearing devices. Unfortunately, for various reasons (e.g., distance, shadowing, fading, interference, etc.), the link quality between the source device and each of the first and second hearing devices may rapidly deteriorate, resulting in the failure of one or both of the first and second hearing devices to receive a transmitted packet from the source device.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary configuration in which a hearing system is configured to communicate with a source device by way of a selectively established wireless link according to principles described herein.

FIG. 2 illustrates an exemplary configuration in which hearing devices included in a hearing system both receive audio packets from the source device into buffers according to principles described herein.

FIGS. 3-6 illustrate exemplary diagrams of relaying and updating payload counter data according to principles described herein.

FIG. 7 illustrates an exemplary method for performing an action based on payload counter data according to principles described herein.

### DETAILED DESCRIPTION

Exemplary systems and methods for relaying and updating payload counter data between hearing devices are described herein. For example, a system may comprise a first hearing device for use with a first ear of a user and a second hearing device for use with a second ear of a user. The first hearing device may be configured to receive, from a source device, a data packet; increment, in response to receiving the data packet, a first payload counter value; receive, from the second hearing device, a second payload counter value; compare the second payload counter value to the first payload counter value; and perform, based on the comparing, an action with respect to the first receiving payload counter value.

For example, if the first hearing device determines that the second payload counter value is greater than the first payload counter value, the first hearing device may update the first payload counter value to match the second payload counter value. Alternatively, if the first hearing device determines that the second payload counter value is less than the first payload counter value, the first hearing device may transmit the first payload counter value to the second hearing device. Alternatively, if the first hearing device determines that the second payload counter is equal to the first payload counter value, the first hearing device may maintain unchanged the first payload counter value.

The systems and methods described herein may advantageously facilitate accurate transmission of data between a source and binaural hearing devices by way of a secure data connection. For example, the systems and methods described herein may allow the hearing devices to efficiently and quickly detect packet reception errors and correct them to minimize the number of packets that are not received by the hearing devices. For at least these reasons, the systems and methods described herein may advantageously increase performance, reliability, and ease of use for hearing device users compared to conventional hearing devices. These and other benefits of the systems and methods described herein will be made apparent herein.

As used herein, the term “data packet” and “packet” are used interchangeably to refer to any type of data that may be transmitted by a source device to hearing devices. For example, a data packet may include an audio packet, which refers to any sample, portion, or other type of audio data representative of or otherwise associated with streaming audio that is provided by a source device. A data packet may additionally or alternatively include signaling data, configuration data, programming data, and/or any other type of data as may serve a particular implementation.

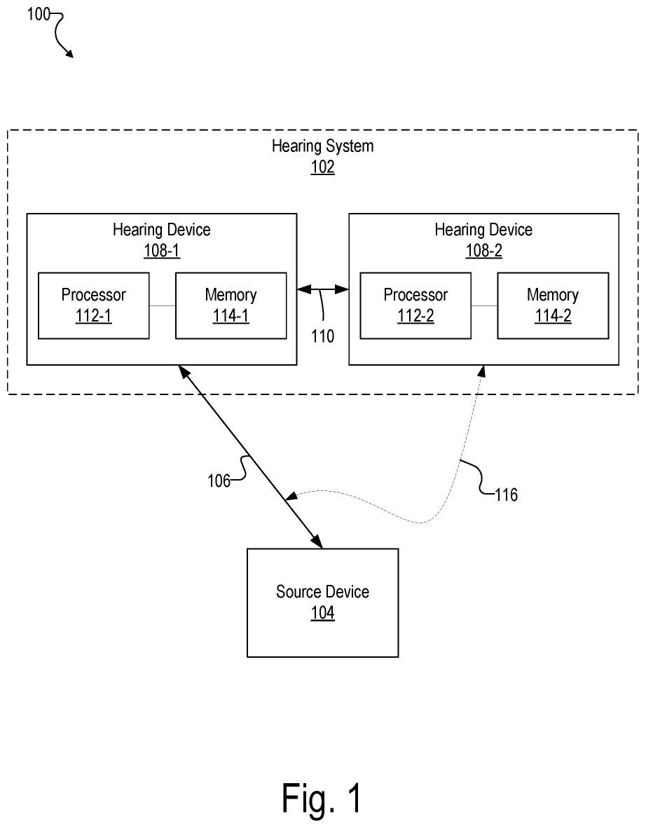

FIG. 1 illustrates an exemplary configuration 100 in which a hearing system 102 (e.g., a binaural hearing system) is configured to communicate with a source device 104 by way of a selectively established wireless link 106. As shown, hearing system 102 includes a first hearing device 108-1 and a second hearing device 108-2 (collectively “hearing devices 108”). Hearing devices 108 may communicate one with another by way of a wireless support link 110.

Source device 104 may include any computing device that outputs data (e.g., streaming audio data, non-audio data, and/or any other type of data that may be used by hearing devices 108) and that is capable of being wirelessly connected with one of hearing devices 108. For example, source device 104 may be a mobile device (e.g., a mobile phone such as a smartphone, a tablet computer, a laptop computer, a mobile gaming device), a desktop computer, a television, a speaker, etc. As described herein, source device 104 may wirelessly transmit streaming audio to hearing system 102 in the form of sequential audio packets (e.g., discrete units or pieces of data representative of the streaming audio). In some examples, source device 104 may additionally or alternatively wirelessly transmit other types of data packets (e.g., signaling packets, etc.) to hearing system 102 at various times before, after, or during the transmission of the sequential audio packets.

Hearing devices 108 may each be implemented by any type of hearing device configured to provide or enhance hearing to a user of hearing system 102. For example, hearing devices 108 may each be implemented by a hearing aid configured to apply amplified audio content to a user, a sound processor included in a cochlear implant system configured to apply electrical stimulation representative of audio content to a user, a sound processor included in an electro-acoustic stimulation system configured to apply electro-acoustic stimulation to a user, a head-worn headset, an ear-worn ear-bud or any other suitable hearing prosthesis. In some examples, hearing device 108-1 is of a different type than hearing device 108-2. For example, hearing device 108-1 may be a hearing aid and hearing device 108-2 may be a sound processor included in a cochlear implant system.

As shown, each hearing device 108 includes a processor and a memory. For example, hearing device 108-1 includes a processor 112-1 and a memory 114-1. Likewise, hearing device 108-2 includes a processor 112-2 and a memory 114-2.

Processors 112 (e.g., processor 112-1 and processor 112-2) are configured to perform various processing operations, such as receiving and processing streaming audio transmitted by source device 104. Processors 112 may each be implemented by any suitable combination of hardware and software.

Memories 114 (e.g., memory 114-1 and memory 114-2) may be implemented by any suitable type of storage medium and may maintain (e.g., store) data utilized by processors 112. For example, memories 114 may store data representative of an operation program that specifies how each processor 112 processes and delivers audio content to a user. To illustrate, if hearing device 108-1 is a hearing aid, memory 114-1 may maintain data representative of an operation program that specifies an audio amplification scheme (e.g., amplification levels, etc.) used by processor 112-1 to deliver acoustic content output by source device 104 to the user. As another example, if hearing device 108-1 is a sound processor included in a cochlear implant system, memory 114-1 may maintain data representative of an operation program that specifies a stimulation scheme used by hearing device 108-1 to direct a cochlear implant to apply electrical stimulation representative of acoustic content output by source device 104 to the user. As will be described below, memories 114 may maintain buffers within which audio packets received from source device 104 may be stored.

Hearing devices 108 may communicate with each other (e.g., by transmitting data) by way of a wireless support link 110 that interconnects hearing devices 108. Wireless support link 110 may include any suitable wireless communication link as may serve a particular implementation.

To facilitate communication between hearing system 102 and source device 104, one of hearing devices 108 may establish a wireless link with source device 104. For example, as shown in FIG. 1, hearing device 108-1 may establish wireless link 106 with source device 104. Wireless link 106 may include a Bluetooth link (e.g., a Bluetooth classic link or a Bluetooth low energy link), a near field communication link, or any other suitable point-to-point link. To this end, hearing devices 108 and source device 104 may each include a wireless interface configured to operate in accordance with any suitable wireless communication protocol. In some examples, as described herein, wireless link 106 is implemented by a secure wireless link such that data transmitted by way of wireless link 106 is encrypted.

Hearing device 108-1 may receive data packets transmitted from source device 104 over wireless link 106 in accordance with an acknowledgement-based transmission protocol (also referred to as an automatic repeat query (“ARQ”) protocol). For example, hearing device 108-1 may receive audio packets from source device 104 over wireless link 106. This may allow hearing device 108-1 to render (e.g., process and play back) streaming audio from source device 104.

The acknowledgement-based transmission protocol requires hearing device 108-1 to acknowledge successful receipt of a data packet transmitted by source device 104 before source device 104 transmits a subsequent data packet. Exemplary acknowledgement-based transmission protocols include stop-and-wait ARQ, go-back-N ARQ, and selective repeat ARQ. A Bluetooth communication protocol, for example, may use any of these acknowledgement-based transmission protocols.

It may be desirable for hearing device 108-2 to receive the same data from source device 104 that hearing device 108-1 receives. For example, it may be desirable for hearing device 108-2 to render streaming audio from source device 104 while hearing device 108-1 renders the streaming audio. However, in some examples, hearing device 108-2 cannot or does not establish its own wireless link with source device 104 while hearing device 108-1 is connected with source device 104 by way of wireless link 106. For example, the communication protocol used by hearing devices 108 and source device 104 to establish wireless links therebetween may not allow both hearing devices 108 to be concurrently connected to source device 104.

In these examples, hearing device 108-2 may receive the data packets transmitted from source device 104 by eavesdropping on wireless link 106. This eavesdropping is illustrated by dashed line 116 in FIG. 1. Hearing device 108-2 may eavesdrop on wireless link 106 by passively listening to (e.g., having access to) data traffic (e.g., audio packets) transmitted between source device 104 and hearing device 108-1. The eavesdropping may be done without source device 104 being aware that hearing device 108-2 is accessing the data traffic and without hearing device 108-2 transmitting any data to source device 104.

To enable eavesdropping by hearing device 108-2 on wireless link 106, hearing device 108-1 may transmit, over wireless support link 110, eavesdropping instructions to hearing device 108-2. The eavesdropping instructions may include information (e.g., frequency hopping sequence information, clock frequency and phase offset information, encryption key information, address information, etc.) that allows hearing device 108-2 to detect audio packets that are wirelessly transmitted from source device 104 to hearing device 108-1. Hearing device 108-2 may accordingly use the eavesdropping instructions to eavesdrop on wireless link 106.

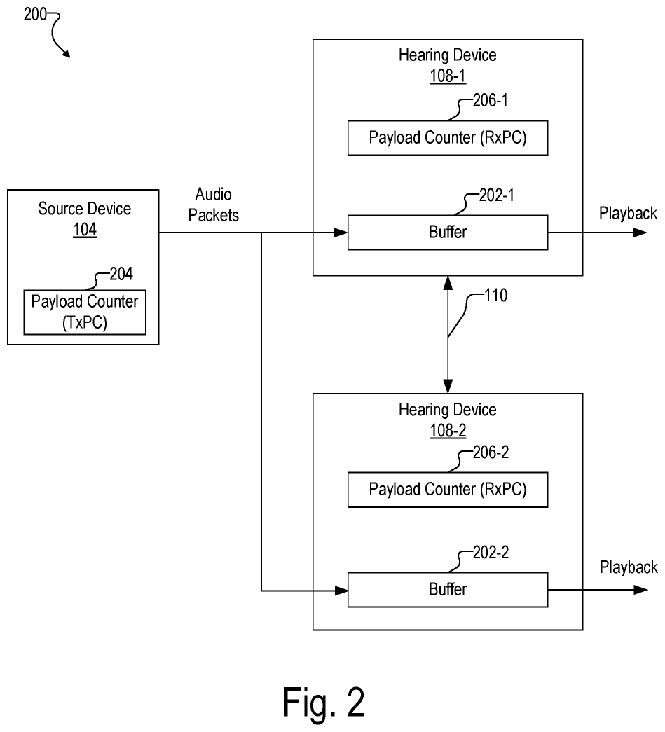

FIG. 2 illustrates an exemplary configuration 200 in which hearing devices 108 both render streaming audio from source device 104. As shown, source device 104 transmits sequential audio packets, which are received by both hearing device 108-1 and hearing device 108-2. As described in connection with FIG. 1, hearing device 108-1 may receive the audio packets over wireless link 106 and hearing device 108-2 may receive the audio packets by eavesdropping on wireless link 106.

As shown, hearing device 108-1 stores the audio packets in a buffer 202-1. Likewise, hearing device 108-2 stores the audio packets in a buffer 202-2. Buffer 202-1 and buffer 202-2 (collectively “buffers 202”) may be maintained within memory 114-1 and memory 114-2, respectively, and may each be of any suitable size (e.g., buffers 202 may each store any suitable number of audio packets).

Hearing devices 108 may render streaming audio from source device 104 by playing back audio packets stored within buffers 202. For example, hearing device 108-1 may render streaming audio from source device 104 by playing back audio packets stored within buffer 202-1. Likewise, hearing device 108-2 may render streaming audio from source device 104 by playing back audio packets stored within buffer 202-2. In so doing, the audio packets that are played back may be removed from buffers 202. Hearing devices 108 may use any suitable processing technique to play back audio packets stored within buffers 202.

Playback of audio packets in buffers 202 may occur while additional audio packets are being received and stored within buffers 202. In this manner, buffers 202 may allow continuous rendering of streaming audio from source device 104 as the audio is generated and transmitted by source device 104.

An audio packet may be stored in a buffer (e.g., one of buffers 202) in any suitable manner. For example, an encoded and/or compressed version of an audio packet (instead of the audio packet itself) may be stored in a buffer.

In some instances, it may be desirable to heighten the security of wireless link 106 using a security protocol to enable the link to be more secure against third party attacks. A heightened security protocol may, for example, facilitate the use of encryption keys, codes, and/or checks to ensure reliable transmission and receipt of authentic data packets. In these instances, source device 104, hearing device 108-1, and hearing device 108-2 may be configured to pair/communicate with each other using the security protocol and encrypt/decrypt data packets in accordance with security protocol rules.

An example of a heightened security protocol that may be used with source device 104, hearing device 108-1, and hearing device 108-2 is Bluetooth Secure Connections, which offers heightened security compared to a Bluetooth connection with legacy security. For illustrative purposes, some of these differences will be discussed herein. For example, when using Bluetooth Secure Connections, each device may use a Diffie-Hellman random private encryption key during the secure pairing procedure that has an increased length of 256 bits (compared to 192 bits when Secure Connections is not used). Additionally, data packets exchanged over the Bluetooth link using Secure Connections can be encrypted using the Advanced Encryption Standard (AES) and are protected by Counter with Cipher Block Chaining-Message Authentication Code (CCM). In this way, a device can append a 4-byte Message Integrity Check (MIC) to an encrypted packet that the device transmits to authenticate its payload. This encryption and MIC computation are based on a current payload counter, which is a 36-bit value that starts at zero for the first encrypted packet in each direction after encryption is started or resumed and increments every time an encrypted payload is accepted by a remote device.

In the embodiment shown, source device 104 maintains a transmission payload counter (TxPC) 204 and each of hearing device 108-1 and 108-2 maintains its own receiving payload counter (RxPC) 206-1 and 206-2, respectively. A value of transmission payload counter 204 is incremented by source device 104 for each new encrypted packet that is transmitted by source device 104. In the embodiment shown, each hearing device 108 increments a value of its own receiving payload counter 206 independently from the other hearing device based on the number of packets it receives from source device 104. For example, hearing device 108-1 increments a value of receiving payload counter 206-1 for each new encrypted packet that it receives from source device 104 and hearing device 108-2 increments a value of receiving payload counter 206-2 for each new encrypted packet that it receives from source device 104.

Each of hearing device 108-1 and 108-2 uses a value of its respective receiving payload counter 206-1 and 206-2 to decrypt the payload and the MIC of a received encrypted packet and to compute a local version of the MIC. If the value of the receiving payload counter that receives the packet matches the value of the transmission payload counter, the local version of the MIC matches the decrypted value of the MIC and the decrypted payload is authenticated as containing meaningful data. Alternatively, if the value of the receiving payload counter that receives the packet does not match the value of the transmission payload counter, the two MIC values do not match (i.e., a MIC error is determined) and the decrypted payload is not authenticated as containing meaningful data.

In some instances, either hearing device 108-1 or hearing device 108-2 may miss (e.g., not receive) a data packet, resulting in a discontinuity in received data packets. Data packets may be missed for various reasons, such as a transmission error, quality of a connection between hearing devices 108 and source device 104, etc. Additionally, hearing devices 108 may discard data packets for various reasons (e.g., a data packet received with errors, a MIC error, etc.), which may be treated as a missed data packet.

Accordingly, when one of hearing devices 108 (e.g., hearing device 108-1) misses a data packet, the other hearing device 108 (e.g., hearing device 108-2) may be configured to relay the data packet by way of wireless support link 110 to the hearing device that missed the data packet. Receiving the missed data packet from the other hearing device may be more efficient than requesting a retransmission from source device 104, as wireless support link 110 may be more stable than wireless link 106.

However, as data packets may be sent by source device 104 asynchronously, it may not be apparent when either of hearing devices 108 has missed a data packet. Hearing devices 108 may not determine that a data packet has been missed until a subsequent data packet in a sequence of data packets is received. Thus, it may not be apparent when either of hearing devices 108 should relay audio data to the other.

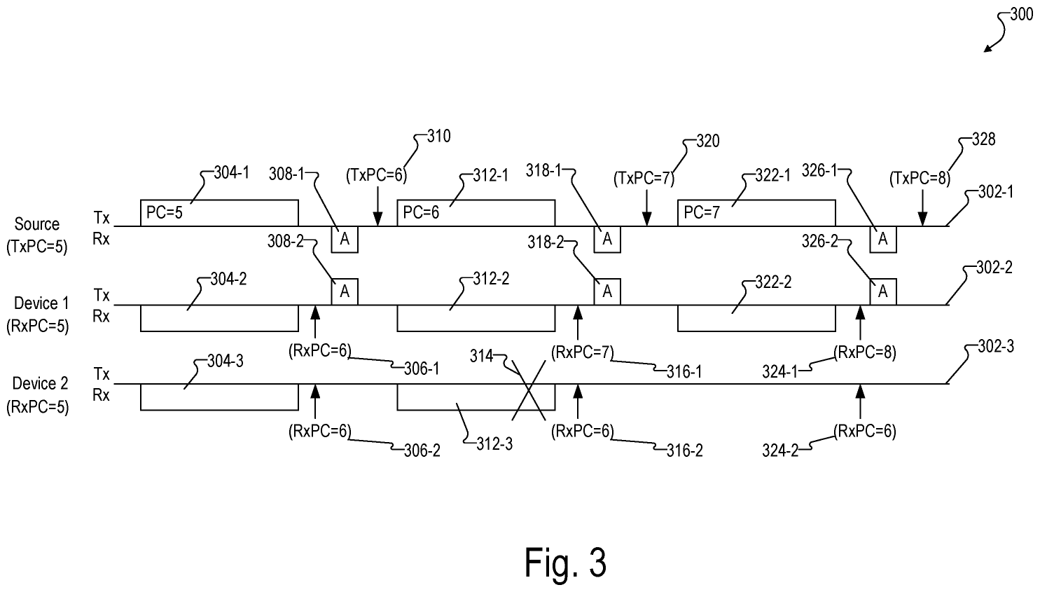

To illustrate, FIG. 3 shows an exemplary diagram 300 that shows a state where hearing devices 108-1 and 108-2 are each configured to receive a sequence of data packets from source device 104, but hearing device 108-2 misses a data packet. Diagram 300 includes a line 302-1 showing various events performed by source device 104, a line 302-2 showing various events performed by hearing device 108-1, and a line 302-3 showing various events performed by hearing device 108-2.

In this example, transmission payload counter 204 has a value TxPC that represents a number of data packets sent from source device 104 and receiving payload counters 206-1 and 206-2 have values RxPC that represent a number of data packets received by each of hearing devices 108-1 and 108-2, respectively. As described herein, transmission payload counter 204 increments value TxPC each time source device 104 transmits a new data packet, and each of receiving payload counters 206-1 and 206-2 is configured to increment its respective value RxPC each time hearing device 108-1 and 108-2 receives a new data packet, respectively. Transmission and receiving payload counter values are referred to herein simply as payload counter values maintained by their respective devices.

In the embodiment shown, a current TxPC value is initially set to 5, indicating that the next new data packet to be transmitted by source device 104 has a payload counter of 5. The current RxPC values of hearing devices 108-1 and 108-2 are also initially set to 5, indicating that each of hearing devices 108-1 and 108-2 is expecting a new data packet with the payload counter of 5.

At event 304-1, source device 104 transmits a first data packet with a payload counter of 5. At events 304-2 and 304-3, hearing device 108-1 and hearing device 108-2 receive the first data packet. Upon receiving the first data packet, hearing devices 108-1 and 108-2 increment their respective RxPC values from 5 to 6 at events 306-1 and 306-2, respectively.

At event 308-2, hearing device 108-1 transmits an acknowledgement of receiving the first data packet. At event 308-1, source device 104 receives the acknowledgement. Upon receiving the acknowledgement, source device 104 increments the TxPC value from 5 to 6 at event 310.

At event 312-1, source device 104 transmits a second data packet with a payload counter of 6. At event 312-2, hearing device 108-1 receives the second data packet. However, as indicated by error 314 superimposed on event 312-3, hearing device 108-2 misses the second data packet. Error 314 may be caused by hearing device 108-2 failing to authenticate the second data packet and discarding it. Alternatively, hearing device 108-2 may fail to receive the second data packet at all due to a deterioration of the link quality with source device 104 and/or for any other reason.

Upon receiving the second data packet, hearing device 108-1 increments its RxPC value from 6 to 7 at event 316-1. However, due to error 314, the RxPC value of hearing device 108-2 remains at 6, as indicated by event 316-2, indicating that hearing device 108-2 missed the second data packet. At event 318-2, hearing device 108-1 transmits an acknowledgement of receiving the second data packet. At event 318-1, source device 104 receives the acknowledgement. Upon receiving the acknowledgement, the TxPC value of source device 104 is incremented from 6 to 7 at event 320. Because source device 104 only receives acknowledgements from hearing device 108-1, source device 104 is not aware of error 314 and continues to transmit the next sequential data packet.

At event 322-1, source device 104 transmits a third data packet with a payload counter of 7. At event 322-2, hearing device 108-1 receives the third data packet. However, line 302-3 shows hearing device 108-2 missing the third data packet (by not displaying a corresponding event on line 302-3). Upon receiving the third data packet, the hearing device 108-1 increments its RxPC value from 7 to 8 at event 324-1. However, due to the failure to receive the third data packet, the RxPC value of hearing device 108-2 still remains at 6, as indicated by event 324-2, indicating that hearing device 108-2 also missed the third data packet. At event 326-2, hearing device 108-1 transmits an acknowledgement of receiving the third data packet. At event 326-1, source device 104 receives the acknowledgement. Upon receiving the acknowledgement, the TxPC value of source device 104 is incremented from 7 to 8 at event 328.

In the embodiment shown, because the value of receiving payload counter 206-2 of hearing device 108-2 does not match the value of transmission payload counter 204 (e.g. due to the previously missed packet), hearing device 108-2 will detect MIC errors when attempting to decrypt new packets received from source device 104. In such a situation, hearing device 108-2 is not able to correctly decrypt the content of any newly received packet until the value of receiving payload counter 206-2 again matches the value of transmission payload counter 204, even if no further errors occur during the actual wireless reception.

When receiving packets over a regular Bluetooth link, hearing devices 108 may periodically transmit to each other a sequence number of a last of the sequential data packets received without discontinuity. As hearing devices 108 receive the transmitted sequence number, if either one of hearing devices 108 has received a data packet that is next in sequence after the received sequence number, the one of hearing devices 108 may autonomously transmit to the other of hearing devices 108 the data packet that is next in sequence. In this manner, both hearing devices 108 may efficiently be kept synchronized and up to date in received data packets. However, as discussed above and shown in FIG. 3, when using a heightened security protocol, a hearing device is unable to correctly decrypt the contents of any newly received packet as long as its receiving payload counter is unsynchronized. In this case, multiple packets may be missed between the periodic sequence number transmissions between hearing devices 108 and may not be able to be recovered. Therefore, the systems and methods described herein allow any unsynchronized payload counter values to be synchronized as quickly as possible so that the number of missed packets may be minimized.

In some examples, hearing device 108-1 and hearing device 108-2 may regularly share their respective current receiving payload counter values with each other at a protocol level via support link 110. When hearing device 108-1 detects that its payload counter value is asynchronous with the payload counter value of hearing device 108-2, hearing device 108-1 may relay its current payload counter value directly to hearing device 108-2 over support link 110 and may receive the current payload counter value of hearing device 108-2 directly from hearing device 108-2 over support link 110. Hearing device 108-1 may then perform any of a number of predetermined actions based on a comparison of the current payload counter values.

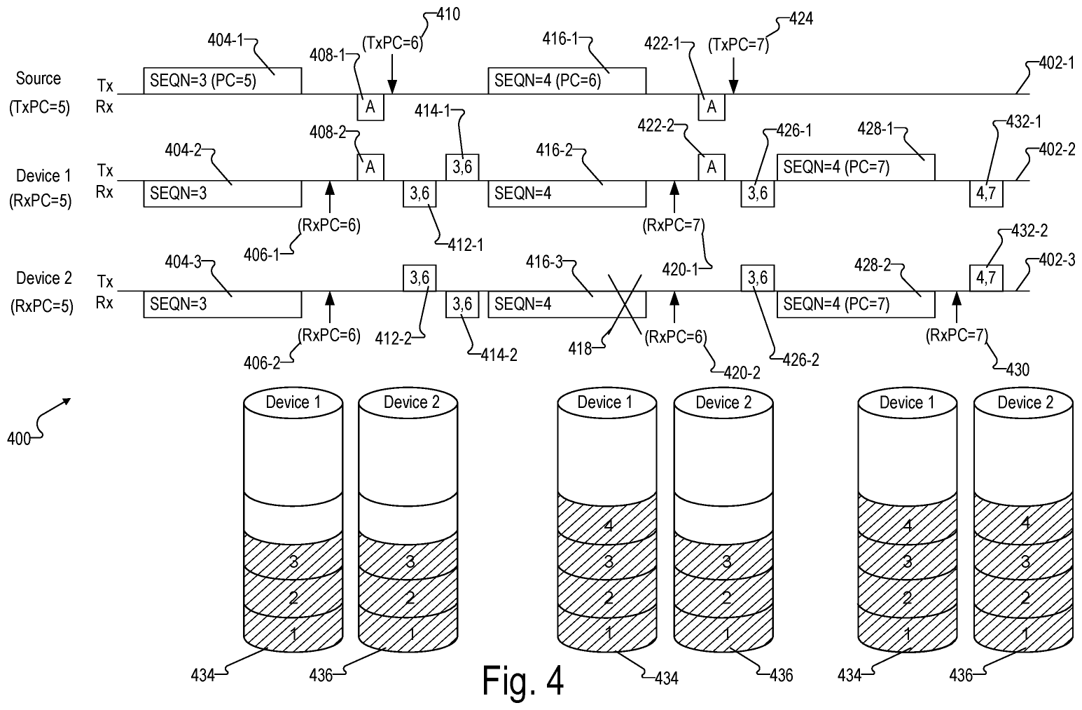

FIG. 4 illustrates an exemplary diagram 400 that shows a process for relaying payload counter data between hearing devices 108-1 and 108-2 received from source device 104. Diagram 400 includes a line 402-1 showing various events performed by source device 104, a line 402-2 showing various events performed by hearing device 108-1, and a line 402-3 showing various events performed by hearing device 108-2.

In the embodiment shown, a transmission payload counter value TxPC represents a number of data packets sent from source device 104 and receiving payload counter values RxPC represent a number of data packets received by each of hearing devices 108-1 and 108-2, respectively. The data packets transmitted by the source device may include any type of data packet (e.g., audio packets, signaling packets, etc.).

In the embodiment shown, a current TxPC value is initially set to 5, indicating that the next new packet to be transmitted by source device 104 has a payload counter of 5. The current RxPC values of hearing devices 108-1 and 108-2 are also initially set to 5, indicating that each of hearing devices 108-1 and 108-2 is expecting a new packet with the payload counter of 5.

At event 404-1, source device 104 transmits a first data packet with a sequence number of 3 (represented as SEQN=3). At events 402-2 and 402-3, hearing device 108-1 and hearing device 108-2 receive the first data packet. In the embodiment shown, the first data packet has a payload counter value of 5 (represented as PC=5) corresponding to the current TxPC and RxPC payload counter values.

At events 404-2 and 404-3, hearing device 108-1 and hearing device 108-2 receive the first data packet. Upon receiving the first data packet, hearing device 108-1 increments its RxPC value from 5 to 6 at event 406-1 and hearing device 108-2 increments its RxPC value from 5 to 6 at event 406-2. At event 408-2, hearing device 108-1 transmits an acknowledgement of receiving the first data packet. At event 408-1, source device 104 receives the acknowledgement. Upon receiving the acknowledgement, source device 104 increments the TxPC value from 5 to 6 at event 410.

In the embodiment shown, before another packet is transmitted from source device 104, hearing devices 108-1 and 108-2 communicate with each other via support link 110. For example, at event 412-2, hearing device 108-2 transmits its current payload counter value corresponding to the most recent data packet it received (in this case, 6). At event 414-1, hearing device 108-1 receives the payload counter value (in this case, 6) transmitted by hearing device 108-2. Likewise, at event 414-1, hearing device 108-1 transmits its current payload counter value corresponding to the most recent data packet it received (in this case, 6). At event 414-2, hearing device 108-2 receives the payload counter value (in this case, 6) transmitted from hearing device 108-1.

As a result of one or more of these transmissions, hearing device 108-1 determines that the first payload counter value is equal to the second payload counter value of hearing device 108-2. Because this determination means that both hearing devices are synchronous and have received all packets transmitted from source device 104, no additional action is taken by hearing device 108-1 and the current payload counter value for hearing device 108-1 is maintained unchanged.

In some embodiments, hearing device 108-2 may also transmit the current sequence number corresponding to the most recent data packet it received (in this case, 3) in addition to the second payload counter value, as represented by event 412-2. In these embodiments, hearing device 108-1 may also receive the current sequence number (in this case, 3) transmitted from hearing device 108-2, as represented by event 414-1. Similarly, hearing device 108-1 may transmit the current sequence number corresponding to the most recent data packet it received (in this case, 3) in addition to the first payload counter value, as represented by event 412-1. Hearing device 108-2 may then also receive the current sequence number (in this case, 3) transmitted from hearing device 108-1, as represented by event 414-2.

Additionally, diagram 400 shows states of corresponding buffers 434 and 436 (e.g., buffers 202) of hearing devices 108-1 and 108-2, respectively. In this example, hearing device 108-1 has previously received data packets with sequence numbers 1 and 2, and so buffer 434 shows data packets 1, 2, and 3. Likewise, because hearing device 108-2 has also previously received data packets with sequence numbers 1 and 2, buffer 436 also shows data packets 1, 2, and 3. Thus, for both hearing device 108-1 and hearing device 108-2, a most recent sequential data packet received at this point without discontinuity is data packet 3 and the current payload counter values are 6. Therefore, as discussed above using binaural communication via support link 110, hearing device 108-1 may transmit the first current payload counter value to hearing device 108-2. Likewise, hearing device 108-2 may transmit the second current payload counter value to hearing device 108-1. As neither hearing device 108-1 nor hearing device 108-2 has yet received any subsequent packets to data packet 3, both hearing devices 108 are up to date and neither transmits a data packet to the other.

At event 416-1, source device 104 transmits a second data packet (e.g., a data packet with sequence number 4 and payload counter number 6). At event 416-2, hearing device 108-1 receives the second data packet. However, as represented by error 418 superimposed on event 416-3, hearing device 108-2 misses the second packet. As previously discussed, error 418 could cause hearing device 108-2 to miss the second data packet for multiple reasons.

Upon receiving the second data packet, hearing device 108-1 increments its RxPC value from 6 to 7 at event 420-1. However, due to error 418, the RxPC value of hearing device 108-2 remains at 6 at event 420-2, indicating that hearing device 108-2 missed the second data packet. At event 422-2, hearing device 108-1 transmits an acknowledgement of receiving the second data packet. At event 422-1, source device 104 receives the acknowledgement. Upon receiving the acknowledgement, source device 104 increments the TxPC value from 6 to 7 at event 424. Correspondingly, in the embodiment shown, buffer 434 holds data packets 1 through 4 at this point. However, because hearing device 108-2 missed the second data packet, buffer 436 still only holds data packets 1 through 3 at this point. Accordingly, the sequence number of the most recent received data packet without discontinuity for hearing device 108-1 is 4, while for hearing device 108-2 the sequence number is 3.

In the embodiment shown, before another packet is transmitted from source device 104, hearing device 108-2 communicates with hearing device 108-1 via support link 110. For example, at event 426-2, hearing device 108-2 transmits the second payload counter value (in this case, 6) and the current sequence number (in this case, 3) corresponding to the most recent data packet it received. At event 426-1, hearing device 108-1 receives the second payload counter value and the current sequence number transmitted from hearing device 108-2.

Upon receiving the second payload counter value from hearing device 108-2, hearing device 108-1 compares the second payload counter value to the first payload counter value. In the embodiment shown, hearing device 108-1 determines, based on the comparison, that the second payload counter value of 6 is less than the first payload counter value of 7. Because this determination means that hearing device 108-2 has missed the most recent packet transmitted from source device 104 and is now asynchronous with hearing device 108-1, hearing device 108-1 transmits the first payload counter value to hearing device 108-2 via support link 110. Upon receiving the first payload counter value from hearing device 108-1, hearing device 108-2 updates its RxPC to match the first payload counter value. Hearing device 108-2 is then able to again correctly receive encrypted data packets from source device 104. In some embodiments, hearing device 108-2 receives the second data packet that it previously missed from source device 104 via eavesdropping.

Alternatively, in the embodiment shown, hearing device 108-1 transmits the second data packet to hearing device 108-2 in addition to transmitting the first payload counter value. This transmission is represented by event 428-1, and the receiving of the second data packet by hearing device 108-2 is represented by event 428-2. Upon receiving the first payload counter value, hearing device 108-2 increments its own RxPC value from 6 to 7 at event 430. Correspondingly, in the embodiment shown, both buffers 434 and 436 hold data packets 1-4.

As represented by events 432-1 and 432-2, the exchange of payload counter values and current sequence numbers between hearing devices 108-1 and 108-2 may continue as described herein.

In some alternative situations, error 418 may occur at event 416-2 instead of at event 416-3. In this instance, hearing device 108-2 will receive the second data packet at event 416-3 while hearing device 108-1 will miss the second data packet. Upon receiving the second data packet, hearing device 108-2 will increment its RxPC value from 6 to 7. However, due to error 418 occurring at event 416-2 instead of event 416-3, the RxPC value of hearing device 108-1 will remain at 6, indicating that hearing device 108-1 missed the second data packet.

In this embodiment, before another packet is transmitted from source device 104, hearing device 108-2 transmits the second payload counter value (in this case, 7) to hearing device 108-1. Upon receiving the second payload counter value from hearing device 108-2, hearing device 108-1 compares the second payload counter value to the first payload counter value. In this embodiment, hearing device 108-1 determines, based on the comparison, that the second payload counter value is greater than the first payload counter value. Because this determination means that hearing device 108-1 has missed the most recent packet transmitted from source device 104 and is now asynchronous with hearing device 108-2, hearing device 108-1 updates the first payload counter value to match the second payload value of hearing device 108-2 and restore synchronicity with hearing device 108-2. Upon updating the first payload counter value, hearing device 108-1 is enabled to again correctly receive encrypted data packets from source device 104.

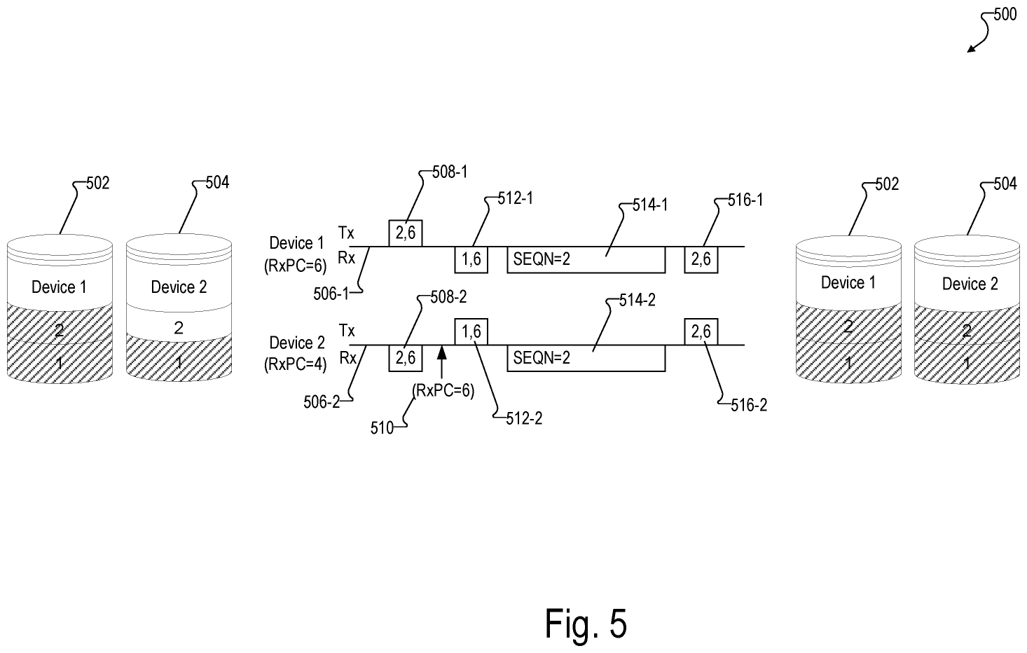

FIG. 5 illustrates another example diagram 500 for relaying payload counter data between hearing devices 108-1 and 108-2. Diagram 500 shows states of buffers 502 and 504 of hearing devices 108-1 and 108-2, respectively, that indicate data packets that were received from source device 104 and data packets that were missed. For example, the buffer 502 on the left side of FIG. 5 shows that hearing device 108-1 received data packets 1 and 2. The buffer 504 on the left side of FIG. 5 shows that hearing device 108-2 has only received data packet 1 but missed data packet 2. In this example, a most recent data packet received without discontinuity by hearing device 108-2 starts with sequence number 1, as the first discontinuity is with data packet 2.

Upon receipt of any data packet without errors, hearing devices 108-1 and 108-2 increment their respective payload counter values for each received data packet. In the embodiment shown, hearing device 108-1 has received six data packets and has incremented its current payload counter value to 6 (i.e., first payload counter value, shown as RxPC=6). Hearing device 108-2 has received four data packets and has incremented its current payload counter value to 4 (i.e., second payload counter value, shown as RxPC=4). Because the first and second payload counter values do not match, hearing devices 108-1 and 108-2 are asynchronous and need to be synchronized to prevent further packet loss.

In the embodiment shown, line 506-1 shows hearing device 108-1 transmitting the first payload counter value (in this case, 6) to hearing device 108-2 at event 508-1. A line 506-2 shows hearing device 108-2 receiving, at event 508-2, the first payload counter value from hearing device 108-1. Upon receiving the first payload counter value from hearing device 108-1, hearing device 108-2 compares the first payload counter value to the second payload counter value. In this embodiment, hearing device 108-2 determines, based on the comparison, that the first payload counter value is greater than the second payload counter value. Because this determination means that hearing device 108-2 has missed two data packets transmitted from source device 104 and is now asynchronous with hearing device 108-1, hearing device 108-2 updates the second payload counter (RxPC) value at event 510 to match the first payload counter value (in this case, 6) of hearing device 108-1 and restore synchronicity with hearing device 108-1. Upon updating its RxPC value, hearing device 108-2 is enabled to again correctly receive encrypted data packets from source device 104. In some embodiments, hearing device 108-2 then receives the missed data packets that it previously missed from source device 104 via eavesdropping.

In the embodiment shown, hearing device 108-1 also transmits, at event 508-1, the sequence number of the most recent data packet it received (in this case, 2) to hearing device 108-2, which hearing device 108-2 receives at event 508-2. After updating its RxPC value, hearing device 108-2 transmits the updated RxPC value to hearing device 108-1 at event 512-2. In this embodiment, hearing device 108-2 also transmits, at event 508-2, the sequence number of the most recent data packet it received (in this case, 1) to hearing device 108-1, which hearing device 108-1 receives at event 512-1. Upon receiving the sequence number from hearing device 108-2, hearing device 108-1 compares the received sequence number to its sequence number. In this embodiment, hearing device 108-1 determines, based on the comparison, that the received sequence number of 1 is less than its own sequence number of 2 and that hearing device 108-2 has not received the most recent data packet from source device 104.

At event 514-1, hearing device 108-1 transmits the second data packet to hearing device 108-2, which receives the second data packet at event 514-2. Upon receiving the second data packet, hearing device 108-2 transmits an updated sequence number (in this case, 2) and the second payload counter value (in this case, 6) to hearing device 108-1 at event 516-2. At event 516-1, hearing device 108-1 receives the transmitted updated sequence number and the second payload counter value from hearing device 108-2. Hearing device 108-1 then determines that both its sequence number and the first payload counter value matches those of hearing device 108-2 and thus indicates that synchronicity has been restored. Correspondingly, at this point, buffers 502 and 504 both hold data packets 1 and 2.

While the sequence numbers shown in diagrams 300, 400, and 500 are 1-8, any suitable sequence numbers may be used. Sequence numbers may increase or decrease by any suitable increments or decrements. In some examples, sequence numbers may be a 16-bit number, resetting to 0 or 1 after reaching a maximum value.

Additionally, there may be instances in which source device 104 may reset or skip sequence numbers in transmitted data packets (e.g., a logical link control and adaptation protocol (L2CAP) flush, audio/video synchronization, etc.). In such instances, in an example in which hearing device 108-1 missed a next data packet, hearing device 108-1 may transmit a sequence number N. Hearing device 108-2 may not have an data packet with sequence number N+1, as an event of sequence numbers have been skipped by source device 104, but hearing device 108-2 may have an data packet with a sequence number M that is later in sequence than N+1. As a result, hearing device 108-2 transmits to hearing device 108-1 data packet M. Upon receiving data packet M, hearing device 108-1 and determining M is later in sequence than N+1, hearing device 108-1 may ignore remaining discontinuities before M.

In some examples, the sequence number may not be included in the transmitted data packets. Such sequence numbers may be calculated by the hearing device. The sequence number may be calculated in any suitable manner, for instance, as a basic incremental counter, based on other properties derived from the protocol (e.g., a reception timestamp, etc.), etc.

Furthermore, in some examples, a finer (or alternatively, coarser) granularity may be used than audio packets for relaying audio data. For instance, hearing devices 108-1 and 108-2 may split audio packets into subframes based on a codec or any other suitable algorithms. Hearing devices 108 may then transmit identifiers (e.g., a sequence number and a frame index) that identify missing subframes rather than entire audio packets. In response, hearing devices 108 may selectively transmit subframes of audio data rather than audio packets.

Additionally, while hearing devices 108 have been described in an eavesdropping topology with source device 104, methods described herein may be performed to relay audio and payload counter data by any devices receiving sequential audio data from a source device.

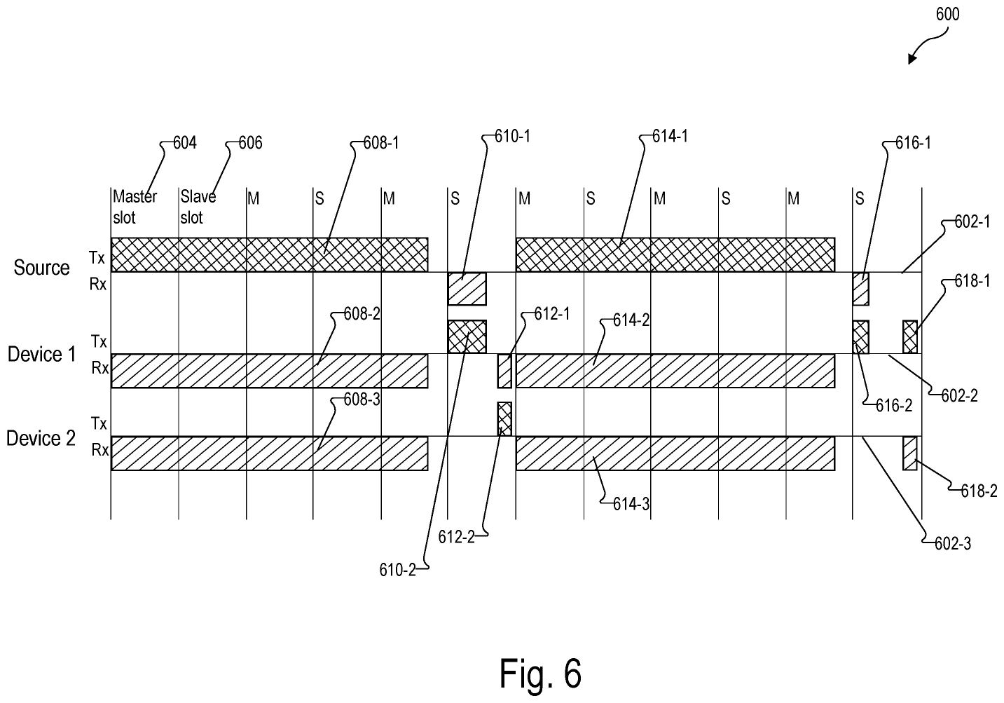

FIG. 6 illustrates an exemplary diagram 600 showing an example timing for relaying payload counter data by hearing devices (e.g., hearing devices 108). Diagram 600 shows a line 602-1 showing data transmitted and received by a source device (e.g., source device 104). A line 602-2 shows data transmitted and received by a hearing device (e.g., hearing device 108-1) and a line 602-3 shows data transmitted and received by an additional hearing device (e.g., hearing device 108-2). The data transmitted and received by source device 104 and hearing devices 108 may be transmitted and received using a dynamic time-division multiple access (TDMA) protocol (e.g., Bluetooth). The TDMA protocol may assign time slots, such as a master slot or transmission frame (e.g., a slot 604) for source device 104 to start transmitting data and a slave slot or response frame (e.g., a slot 606) for hearing devices 108 to start transmitting data.

For instance, source device 104 may start transmitting a data packet at slot 604, a master slot designated for source device 104 to start transmitting data. The data packet transmission is shown by event 608-1, which spans several time slots. Event 608-2 and event 608-3 show the data packet being received by hearing device 108-1 and hearing device 108-2, respectively. A length of the data packets may be configured such that a transmission of the data packet spans at least a portion of an odd number (e.g., 3, 5, etc.) of time slots. By spanning an odd number of time slots, a next time slot after the transmission of the data packet is a slave slot, which provides an opportunity for hearing device 108-1 to acknowledge receiving the data packet. Event 610-2 shows a transmission of a response communication by hearing device 108-1 to source device 104 acknowledging the receiving of the data packet. Event 610-1 shows a receiving of the response communication by source device 104.

In some examples, the transmitting of the response communication by hearing device 108-1 may take less time than a full time slot. As an example, a slave slot or response frame may have a predetermined length of 625 microseconds (μs) and a response communication may only take up to 426 μs. Such timings may leave time at the end of the slave slot for hearing device 108-1 to transmit a current payload counter value to hearing device 108-2 and/or vice versa without introducing additional delay into the transmitting and receiving of audio data from source device 104. In some embodiments, a sequence number corresponding to the most recent data packet received by hearing device 108-1 and/or hearing device 108-2 can also be sent with the current payload counter value at the end of the slave slot.

As shown, an event 612-2 shows hearing device 108-2 transmitting a current payload counter value to hearing device 108-1 and an event 612-1 shows hearing device 108-1 receiving the current payload counter value. As this transmitting and receiving is performed after the response communication is sent to source device 104 and finishes before the end of the slave slot, a next time slot may be available for source device 104 to transmit a next data packet.

As shown, at event 614-1, the next data packet is transmitted by source device 104. Hearing device 108-1 receives the next data packet at event 614-2 and hearing device 108-2 receives the next data packet at event 614-3. At event 616-2, hearing device 108-1 transmits an acknowledgment in a subsequent slave slot. The acknowledgement is received by source device 104 at an event 616-1. In a remaining time of the slave slot, hearing device 108-1 transmits a current payload counter value to hearing device 108-2 at event 618-1. At event 618-2, hearing device 108-2 receives the current payload counter value. While this example shows hearing devices 108 alternating transmission of current payload counter values, any suitable algorithm may be used.

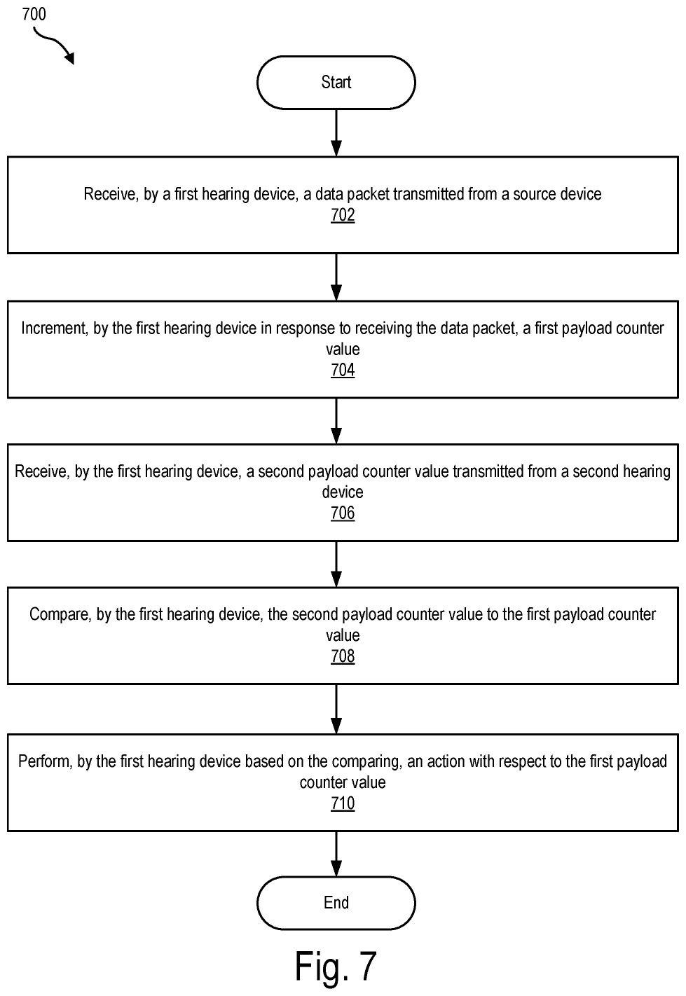

FIG. 7 illustrates an exemplary method 700. One or more of the operations shown in FIG. 7 may be performed by any of the hearing devices described herein. While FIG. 7 illustrates exemplary operations according to one embodiment, other embodiments may omit, add to, reorder, and/or modify any of the operations shown in FIG. 7.

At step 702, a first hearing device receives, from a source, a data packet transmitted from the source device. In some embodiments, the first hearing device may receive multiple data packets that are sequential and that are each identified by a sequence number. The data packet may an audio packet or a packet with a different type of payload. Step 702 may be performed in any of the ways described herein.

At step 704, the first hearing device increments, in response to receiving the data packet, a first payload counter value. The first payload counter value may be a value of a first receiving payload counter associated with the first hearing device. Step 704 may be performed in any of the ways described herein.

At step 706, the first hearing device receives a second payload counter value transmitted from a second hearing device. The second payload counter value may be a value of a second receiving payload counter associated with the second hearing device. Step 706 may be performed in any of the ways described herein.

At step 708, the first hearing device compares the second payload counter value to the first payload counter value. In some examples, the comparison determines whether the second payload counter value is greater than, less than, or equal to the first payload counter value. Step 708 may be performed in any of the ways described herein.

At step 710, the first hearing device performs, based on the comparing, an action with respect to the first payload counter value. Step 710 may be performed in any of the ways described herein.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
receiving, by a first hearing device, a data packet transmitted from a source device;
incrementing, by the first hearing device in response to receiving the data packet, a first payload counter value;
receiving, by the first hearing device, a second payload counter value transmitted from a second hearing device;
comparing, by the first hearing device, the second payload counter value to the first payload counter value; and
performing, by the first hearing device based on the comparing, an action with respect to the first payload counter value.

2. The method of claim 1, wherein:
the comparing comprises determining that the second payload counter value is greater than the first payload counter value; and
the performing of the action comprises updating the first payload counter value to match the second payload counter value.

3. The method of claim 1, wherein:
the comparing comprises determining that the second payload counter value is less than the first payload counter value; and
the performing of the action comprises transmitting the first payload counter value to the second hearing device.

4. The method of claim 3, further comprising:
transmitting, by the first hearing device, the data packet to the second hearing device.

5. The method of claim 3, further comprising:
receiving, by the first hearing device, an updated second payload counter value transmitted from the second hearing device based on the transmitted first payload counter value.

6. The method of claim 1, wherein:
the comparing comprises determining that the second payload counter value is equal to the first payload counter value; and
the performing of the action comprises maintaining unchanged the first payload counter value.

7. The method of claim 1, further comprising:
sending, by the first hearing device during a response frame that has a predetermined length, a response communication to the source device confirming receipt of the data packet.

8. The method of claim 7, wherein the first hearing device receives the second payload counter value transmitted from the second hearing device during the response frame and after the response communication is sent to the source device.

9. The method of claim 1, wherein the data packet is received by the first hearing device from the source device via a Bluetooth connection.

10. The method of claim 1, wherein the data packet is received by the second hearing device from the source device via a Bluetooth eavesdropping topology.

11. The method of claim 9, wherein:
the data packet is encrypted with an encryption key, and
the method further comprises decrypting, by the first hearing device, a payload of the data packet using the first payload counter value.

12. The method of claim 11, further comprising:
decrypting, by the first hearing device, a Message Integrity Check (MIC) appended to the data packet using the first payload counter value;
computing, by the first hearing device, a local version of the MIC using the first payload counter value; and
comparing, by the first hearing device, the decrypted MIC to the local version of the MIC to authenticate the data packet.

13. A system comprising:
a first hearing device for use with a first ear of a user; and
a second hearing device for use with a second ear of a user;
wherein the first hearing device is configured to:
receive, from a source device, a data packet;
increment, in response to receiving the data packet, a first payload counter value;
receive, from the second hearing device, a second payload counter value;
compare the second payload counter value to the first payload counter value; and
perform, based on the comparing, an action with respect to the first payload counter value.

14. The system of claim 13, wherein the second hearing device is configured to:
receive, from the source device via an eavesdropping link between the source device and the second hearing device, the data packet;
increment, in response to receiving the data packet, the second payload counter value prior to the first hearing device receiving the second payload counter value from the second hearing device; and
transmit, to the first hearing device, the second payload counter value.

15. The system of claim 13, wherein:
the comparing comprises determining that the second payload counter value is greater than the first payload counter value; and
the performing of the action comprises updating the first payload counter value to match the second payload counter value.

16. The system of claim 13, wherein:
the comparing comprises determining that the second payload counter value is less than the first payload counter value; and
the performing of the action comprises transmitting the first payload counter value to the second hearing device.

17. The system of claim 16, wherein the first hearing device is further configured to transmit the data packet to the second hearing device.

18. The system of claim 16, wherein the first hearing device is further configured to:
receive, from the second hearing device, an updated second payload counter value transmitted based on the transmitted first payload counter value.

19. The system of claim 13, wherein:
the comparing comprises determining that the second payload counter value is equal to the first payload counter value; and
the performing of the action comprises maintaining unchanged the first payload counter value.

20. A hearing device comprising:
a memory storing instructions;
a processor communicatively coupled to the memory and configured to execute the instructions to:
receive, from a source device, a data packet;
increment, in response to receiving the data packet, a first payload counter value;
receive, from an additional hearing device, a second payload counter value;
compare the second payload counter value to the first payload counter value; and
perform, based on the comparing, an action with respect to the first payload counter value.
